(19) United States
(12) Patent Application Publication
(10) Pub. No.: US 2020/0134764 A1
(43) Pub. Date: Apr. 30, 2020

(54) BOOKING MANAGEMENT SYSTEM

(71) Applicant: International Business Machines Corporation, Armonk, NY (US)

(72) Inventors: Ali Y. Duale, Poughkeepsie, NY (US); Adaoha Onyekwelu, WAPPINGERS FALLS, NY (US); Jeffrey Nettey, Pleasant Valley, NY (US); Abuchi Obiegbu, Poughkeepsie, NY (US); Ronald A. Dartey, Poughkeepsie, NY (US)

(21) Appl. No.: 16/174,546

(22) Filed: Oct. 30, 2018

(51) Int. Cl. G06Q 50/30; G06Q 10/02; G06Q 50/14; H04W 4/02

(52) U.S. Cl. CPC G06Q 50/30; G06Q 10/02; H04L 67/12; H04W 4/02; G06Q 50/14

(57) ABSTRACT

Methods and systems for booking management are provided. Aspects include receiving booking data for a mode of transportation, wherein the booking data includes passenger data and departure data for the mode of transportation, analyzing the passenger data to identify one or more passengers for the mode of transportation, obtaining location data associated with each of the one or more passengers, analyzing the location data to determine at least one potentially late passenger from the one or more passengers, and transmitting a notification to the at least one potentially late passenger based on the location data for the at least one potentially late passenger.

### BACKGROUND

The present invention generally relates to transportation booking systems, and more specifically, to a booking management system using passenger locations data.

Airlines and other transportation companies often face issues related to overbooking passengers for their transportation services. Airlines, in particular, typically have to find passengers who are willing to give up their reserved spot on the airplane in exchange for some type of incentive. These incentives range from upgraded travel accommodations to monetary payments for the ticket. In addition to overbooking issues, the airlines often have to accommodate standby passengers. On most airlines, flying standby occurs when a passenger travels on a flight without a prior reservation for that specific flight. A common occurrence for airlines is that, after a ticket is purchased, a passenger may decide to modify or cancel their travel plans at the last minute. The airlines and other transportation providers are left to figure out how to address these canceled or modified travel plans.

### SUMMARY

Embodiments of the present invention are directed to a computer-implemented method for booking management. A non-limiting example of the computer-implemented method includes receiving booking data for a mode of transportation, wherein the booking data includes passenger data and departure data for the mode of transportation, analyzing the passenger data to identify one or more passengers for the mode of transportation, obtaining location data associated with each of the one or more passengers, analyzing the location data to determine at least one potentially late passenger from the one or more passengers, and transmitting a notification to the at least one potentially late passenger based on the location data for the at least one potentially late passenger.

Embodiments of the present invention are directed to a system for booking management. A non-limiting example of the system includes a processor communicatively coupled to a memory, the processor configured to receive booking data for a mode of transportation, wherein the booking data includes passenger data and departure data for the mode of transportation, analyze the passenger data to identify one or more passengers for the mode of transportation, obtain location data associated with each of the one or more passengers, analyze the location data to determine at least one potentially late passenger from the one or more passengers, and transmit an notification to the at least one potentially late passenger based on the location data for the at least one potentially late passenger.

Embodiments of the invention are directed to a computer program product for booking management, the computer program product comprising a computer readable storage medium having program instructions embodied therewith. The program instructions are executable by a processor to cause the processor to perform a method. A non-limiting example of the method includes receiving booking data for a mode of transportation, wherein the booking data includes passenger data and departure data for the mode of transportation, analyzing the passenger data to identify one or more passengers for the mode of transportation, obtaining location data associated with each of the one or more passengers, analyzing the location data to determine at least one potentially late passenger from the one or more passengers, and transmitting a notification to the at least one potentially late passenger based on the location data for the at least one potentially late passenger.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 depicts a block diagram of a computer system for use in implementing one or more embodiments of the present invention;

FIG. 4 depicts a system for booking management according to one or more embodiments of the invention;

FIG. 5 depicts a flow diagram of a method for booking management according to one or more embodiments of the invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

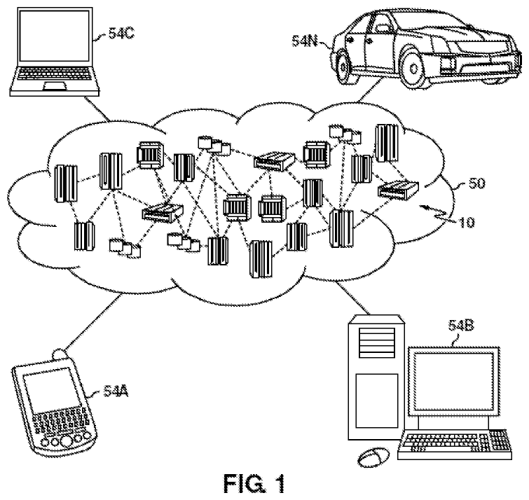

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

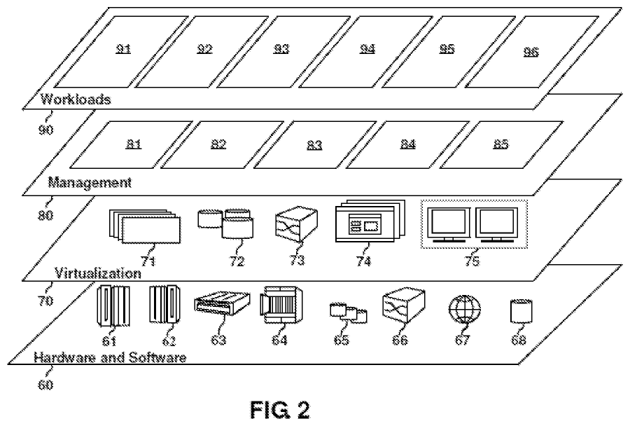

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and booking management 96.

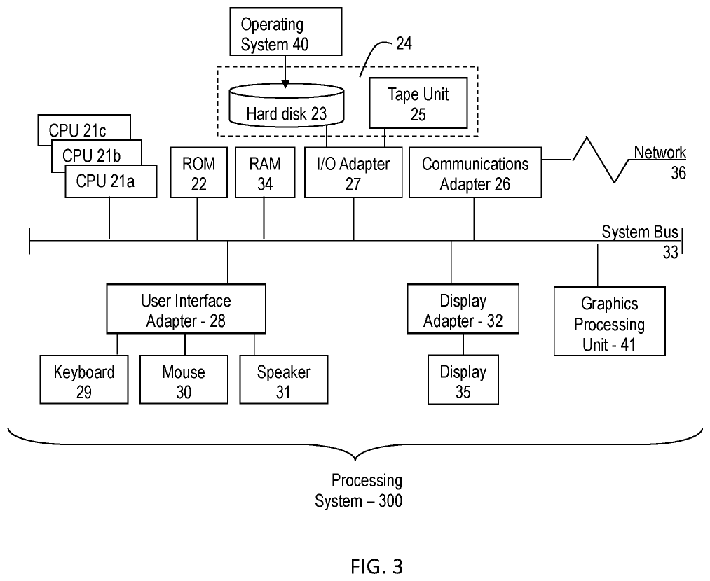

Referring to FIG. 3, there is shown an embodiment of a processing system 300 for implementing the teachings herein. In this embodiment, the system 300 has one or more central processing units (processors) 21a, 21b, 21c, etc. (collectively or generically referred to as processor(s) 21). In one or more embodiments, each processor 21 may include a reduced instruction set computer (RISC) microprocessor. Processors 21 are coupled to system memory 34 and various other components via a system bus 33. Read only memory (ROM) 22 is coupled to the system bus 33 and may include a basic input/output system (BIOS), which controls certain basic functions of system 300.

FIG. 3 further depicts an input/output (I/O) adapter 27 and a network adapter 26 coupled to the system bus 33. I/O adapter 27 may be a small computer system interface (SCSI) adapter that communicates with a hard disk 23 and/or tape storage drive 25 or any other similar component. I/O adapter 27, hard disk 23, and tape storage device 25 are collectively referred to herein as mass storage 24. Operating system 40 for execution on the processing system 300 may be stored in mass storage 24. A network adapter 26 interconnects bus 33 with an outside network 36 enabling data processing system 300 to communicate with other such systems. A screen (e.g., a display monitor) 35 is connected to system bus 33 by display adaptor 32, which may include a graphics adapter to improve the performance of graphics intensive applications and a video controller. In one embodiment, adapters 27, 26, and 32 may be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 all interconnected to bus 33 via user interface adapter 28, which may include, for example, a Super I/O chip integrating multiple device adapters into a single integrated circuit.

In exemplary embodiments, the processing system 300 includes a graphics processing unit 41. Graphics processing unit 41 is a specialized electronic circuit designed to manipulate and alter memory to accelerate the creation of images in a frame buffer intended for output to a display. In general, graphics processing unit 41 is very efficient at manipulating computer graphics and image processing and has a highly parallel structure that makes it more effective than general-purpose CPUs for algorithms where processing of large blocks of data is done in parallel.

Thus, as configured in FIG. 3, the system 300 includes processing capability in the form of processors 21, storage capability including system memory 34 and mass storage 24, input means such as keyboard 29 and mouse 30, and output capability including speaker 31 and display 35. In one embodiment, a portion of system memory 34 and mass storage 24 collectively store an operating system coordinate the functions of the various components shown in FIG. 3.

Turning now to an overview of technologies that are more specifically relevant to aspects of the invention, as described above, transportation providers often have to accommodate passengers that reserve seats for a mode of transportation and then cancel at the last minute. This issue is particularly problematic with airlines as many airline passengers fly stand-by and are assigned a particular seat at or near the boarding process. This can cause delays in boarding and thus delays in departure by the aircraft. These delays in boarding and departure often cause customer un-satisfaction with the airline. There exists a need for a system that can identify potentially late passengers and confirm their desire to board the plane or their desire to cancel or alter their travel plans ahead of time to reduce the boarding delays caused by waiting for last minute passengers.

Turning now to an overview of the aspects of the invention, one or more embodiments of the invention address the above-described shortcomings of the prior art by providing systems and methods for booking management that reduces flight delays and standby passenger wait times. Aspects include identification of passengers that are likely to be late for a departure based on location data associated with the passengers. Once identified, the systems and methods herein can generate a notification for the potentially late passenger(s) to offer a variety of incentives to surrender their seat to another passenger. By using the location of the passengers, the systems and methods described herein can determine potential openings on a flight or other mode of transportation to offer to standby passengers or to accommodate passengers when the flight or another mode of transportation has been overbooked. Also, in one or more embodiments, the systems and methods described herein can identify travel companions for the potentially late passenger(s) and provide notifications that include offers for incentives for the travel companions to give up their seats in order to travel with the late passenger.

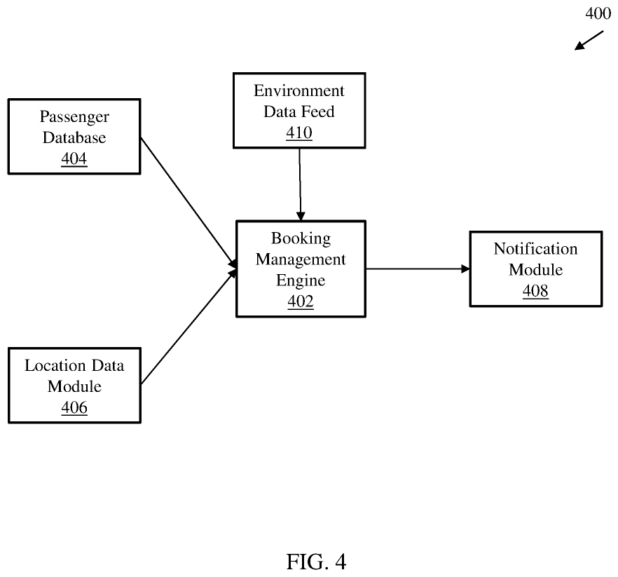

Turning now to a more detailed description of aspects of the present invention, FIG. 4 depicts a system for booking management according to embodiments of the invention. The system 400 includes a booking management engine 402, a passenger database 404, a location data module 406, and a notification module 408. In one or more embodiments of the invention, the booking management engine 402, passenger database, 404, the location data module 406, and the notification module 408 can be implemented on the processing system 300 found in FIG. 3. Additionally, the cloud computing system 50 can be in wired or wireless electronic communication with one or all of the elements of the system 400. Cloud 50 can supplement, support or replace some or all of the functionality of the elements of the system 400. Additionally, some or all of the functionality of the elements of system 400 can be implemented as a node 10 (shown in FIGS. 1 and 2) of cloud 50. Cloud computing node 10 is only one example of a suitable cloud computing node and is not intended to suggest any limitation as to the scope of use or functionality of embodiments of the invention described herein.

In one or more embodiment of the invention, the system 400 manages the assignment of seats and travel arrangements for passengers for a mode of transportation. In the remaining description, the mode of transportation will be that of aircraft travel at an airport. However, in one or more embodiments, the mode of transportation and the system 400 described herein can be applied to any mode of transportation including, but not limited to, trains, rental cars, boats, ships, and the like. In one or more embodiments of the invention, the system 400 can access passenger data from the passenger database 404. The passenger data includes itinerary data associated with each passenger. This itinerary data can include flight numbers, flight times, seat assignments, and the like. The passenger data can also include a passenger profile that stores passenger preference information. These preferences can include travel preferences such as seat class, seat location preference, and travel time preferences. For example, a passenger may not wish to fly at night time or early in the morning. Or a passenger may only wish to fly coach or be seated next to a window. The passenger database 404 can also store passenger data associated with standby passengers that are waiting to be assigned a seat on a flight, but not a specific flight. In this sense, the standby passengers have a designated destination but not a designated flight, seat, time, etc. The passenger preference can also include whether the passenger authorizes the system 400 to have access to their location at or around the time of the flight. For example, when booking a flight, the booking management engine 402 can have the passenger optionally elect to allow the booking management engine 402 to know the passenger location. The passenger location data can be accessed from the location data module 406 which, in one or more embodiments, can be through an application (“app”) on a passenger's smartphone, tablet, or another electronic device. In some embodiments, the location data can be obtained from a passenger's vehicle through an app installed in the vehicle. The passenger can elect to have the location data module 406 identify the passenger's location within a certain amount of time before the flight. For example, the passenger location can only be determined one hour before the flight or thirty minutes before the flight.

In one or more embodiments, the booking management engine 402 before the departure of a flight can access the passenger data and location data for each passenger utilizing the location data module 406. The location of each passenger can be determined from the location data. Using a radius based algorithm, the booking management engine 402 can identify passengers that are likely to be late for the flight departure based on their location. In addition to the passenger location, other factors can be determined by accessing an environment data feed 410. In one or more embodiments, the environment data feed 410 can include a news feed associated with travel conditions to the airport such as, for example, traffic information, weather information, road closures, delays in public transportation, and the like. Based on the location of the passenger and the environment data, the booking management engine 402 can determine potentially late passengers for the flight. Utilizing the notification module 408, the booking management engine 402 can transmit a notification to the potentially late passenger that includes an offer or incentive for the passenger to give up their seat in exchange for another ticket on a later flight or a monetary amount. The potentially late passenger also has the ability to decline the offer. In one or more embodiments, the notification can be sent through an app on the potentially late passenger's smartphone or tablet. In other embodiments, the notification can be sent as a text message. The text message can include a uniform resource locator (URL) or link to a website that can display the offer to the passenger on their phone. The text message can include a description of the offer and how the passenger can accept/decline the offer (e.g., text back “1” to accept, text back “0” to decline, etc.) The notification can be sent to the potentially late passenger via email or an automated phone message.

In one or more embodiments, the itinerary data can include destination data for a passenger. This destination can include hotel information as well as other modes of transportation booked by the passenger such as, for example, a train ticket or rental car reservation. This destination data can be utilized for determining the type of offer or incentive for the late passenger. For example, a passenger may have a hotel reservation that requires the passenger check-in before a certain time. The system 400 would determine an offer (e.g., flight) that would be able to transport the passenger to the hotel in time for check-in and avoid offering the passenger flights that would cause the passenger to miss the check-in deadline.

In one or more embodiments of the invention, the system 400, utilizing automated technology, can identify a flight that is overbooked and start analyzing the location data for all passengers including standby passengers for the overbooked flight. Passengers that fall outside a certain radius or travel time to the airport before the flight can be initially sent a notification to determine if the passenger intends to make the flight. For example, a potentially late passenger may be 30 minutes from the airport based on their location data and traffic data taken from the environment data feed 410. The boarding process closes in 25 minutes. This potentially late passenger can be sent a notification to offer an incentive to give up his or her seat in exchange for money or another seat on a later flight. By identifying this potentially late passenger and confirming that this passenger is willing to give up his or her seat in exchange for an incentive, the system 400 can identify present passengers without seat assignment and assign the present passenger a seat on the plane. This does not hold up the boarding process as the late passenger is identified well ahead of time and the standby or overbooked passenger can be boarded earlier to speed up the boarding process. By efficiently boarding the airplane, the airplane can save on fuel consumption and battery power because the airplane does not have to sit idle at the gate. This also reduces travel time for the other passengers because the flight can take off on time or even early when all passengers are boarded, thus reducing fuel and battery consumption of the aircraft.

In one or more embodiments of the invention, the system 400 can send notifications to the standby passengers for a flight based on the location data of the other passengers. For example, if the booking management engine 402 determines that all or close to all (e.g., 198/200) passengers are present at the airport for the flight, standby passengers can be notified early on that they would not likely get a seat on the flight. This allows the standby passengers to better plan what flights they should try to get on. In most cases, standby passengers are forced to wait at the gate until it is clear (close to departure time) that passengers are not going to make the flight. By confirming locations of the booked passengers ahead of time, the standby passengers are not forced to wait by a gate and instead can plan to attempt to board a different flight to their destination.

In one or more embodiments of the invention, the booking management engine 402 can utilize the location data for each of the passengers to change their boarding zones. For example, if during boarding, a passenger's zone is called and they are a few minutes late due to traffic or they are going through security, the system 400 can change their boarding zone to a later zone (e.g., zone 1 to zone 4) and move a different, present passenger to an earlier zone (e.g., zone 4 to zone 1).

In one or more embodiments of the invention, the passenger data for each passenger can include information about travel companions for the passengers. For example, a potentially late passenger may have purchased two tickets using the same credit card. The booking management engine 402 can determine that the second ticket is likely a travel companion for the potentially late passenger. The booking management engine 402 can send a notification to the travel companion offering the travel companion an offer to give up their seat in exchange for a later flight or for money. The travel companion offer can also include information about what the potentially late passenger's choice was when the potentially late passenger selects an offer. For example, if the potentially late passenger selects to give up their seat in exchange for a later flight, the same later flight can be offered to the travel companion. In one or more embodiments, the booking management engine 402 can automatically update the travel companion's itinerary based on the potentially late passenger's selection. For example, if the potentially late passenger purchased the two tickets and selects an option to travel together should the potentially late passenger be late. This could notify the booking management engine 402 to automatically update travel plans for the travel companion based on the potentially late passenger's travel itinerary.

In one or more embodiments, when a potentially late customer has multiple travel companions on a flight, the booking management engine 402 can transmit a group offer to each individual. The group can vote on whether to select an offer and the winning vote would determine whether the offer or incentive was accepted or declined. For example, a group of nine individuals may be traveling together to a destination. If one or more of the nine individuals are determined to be arriving late based on their location data, the group offer can ask for them to vote on taking a later flight and giving up their seat. Alternatively, the group offer can allow for certain individuals to remain on the current flight or opt-in for the incentive for the later flight or cancel travel altogether.

In one or more embodiments of the invention, the booking management engine 402 can analyze the destination data included in the potentially late passenger's itinerary to determine changes to accommodations for the potentially late passenger based on a selection of an offer. For example, if a potentially late passenger opts for a later flight, the booking management engine 402 may determine that the passenger has a connecting flight or a reservation for a train ride at a certain time. The booking management engine 402 can also offer to alter the bookings or reservations for the connecting flight and/or train ride. In one or more embodiments, the booking management engine 402 can identify alternative means of transportation based on changes to the potentially late passenger's location. For example, if a potentially late passenger is located between two airports and the potentially late passenger will be late for their flight at one airport, the booking management engine 402 might send an offer to the potentially late passenger to go to the second airport for a flight that the potentially late passenger will be able to make that will be close to the departure time of the initial flight. In other embodiments, the booking management engine 402 can identify other modes of transportation to offer as an incentive to the potentially late passenger. For example, if a potentially late passenger is traveling to a destination that also can be traveled to by a direct train ride, the booking management engine 402 could offer the train ride as an incentive and inform the potentially late passenger that they would potentially arrive earlier than if the potentially late passenger took a later flight. The selection of the offer for another mode of transportation can be based on the passenger profile that includes the passenger preference. The preferences can include pricing, timing, etc. For example, if the time of arrival is the most important preference for a potentially late passenger, the mode of transportation (e.g., flight, train, etc.) can be offered despite a price increase. So if a first class ticket is available and the potentially late passenger was flying coach, the offer could include an upgrade that would cost them more but get the potentially late passenger to their destination as soon as possible.

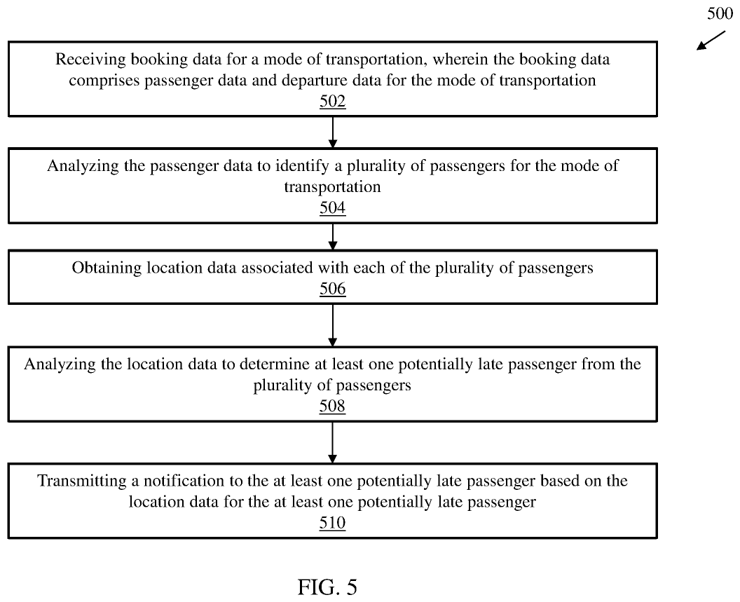

FIG. 5 depicts a flow diagram of a method for booking management according to one or more embodiments of the invention. The method 500 includes receiving booking data for a mode of transportation, wherein the booking data comprises passenger data and departure data for the mode of transportation, as shown at block 502. The method 500, at block 504, includes analyzing the passenger data to identify a plurality of passengers for the mode of transportation. At block 506, the method 500 includes obtaining location data associated with each of the plurality of passengers. Also, the method 500 includes analyzing the location data to determine at least one potentially late passenger from the plurality of passengers, as shown at block 508. And at block 510, the method 500 includes transmitting a notification to the at least one potentially late passenger based on the location data for the at least one potentially late passenger.

Additional processes may also be included. It should be understood that the processes depicted in FIG. 5 represent illustrations, and that other processes may be added or existing processes may be removed, modified, or rearranged without departing from the scope and spirit of the present disclosure.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving booking data for a mode of transportation, wherein the booking data comprises passenger data and departure data for the mode of transportation;
analyzing the passenger data to identify one or more passengers for the mode of transportation;
obtaining location data associated with each of the one or more passengers;
analyzing the location data to determine at least one potentially late passenger from the one or more passengers; and
transmitting a notification to the at least one potentially late passenger based on the location data for the at least one potentially late passenger.

2. The computer-implemented method of claim 1, wherein the notification comprises an offer to sell a ticket for the at least one potentially late passenger.

3. The computer-implemented method of claim 1, further comprising analyzing the passenger data of the at least one potentially late passenger to determine a travel companion.

4. The computer-implemented method of claim 3, further comprising analyzing the location data associated with the travel companion to determine an on-time arrival time for the travel companion.

5. The computer-implemented method of claim 4, further comprising transmitting a companion alert for the travel companion based on the location data for the at least one potentially late passenger.

6. The computer-implemented method of claim 4, further comprising:
rescheduling the travel companion based at least in part on the at least one potentially late passenger accepting an offer in the notification.

7. The computer-implemented method of claim 1, further comprising:
analyzing the passenger data to determine at least one standby passenger for the mode of transportation; and
assigning a ticket to the at least on standby passenger based at least in part on the at least one potentially late passenger accepting an offer in the notification.

8. The computer-implemented method of claim 1, wherein the mode of transportation comprises an airplane.

9. The computer-implemented method of claim 1, wherein the location data is obtained from a user device for each of the one or more passengers.

10. A system for booking management, the system comprising:
a processor communicatively coupled to a memory, the processor configured to:
receive booking data for a mode of transportation, wherein the booking data comprises passenger data and departure data for the mode of transportation;
analyze the passenger data to identify one or more passengers for the mode of transportation;
obtain location data associated with each of the one or more passengers;
analyze the location data to determine at least one potentially late passenger from the one or more passengers; and
transmit an notification to the at least one potentially late passenger based on the location data for the at least one potentially late passenger.

11. The system of claim 10, wherein the notification comprises an offer to sell a ticket for the at least one potentially late passenger.

12. The system of claim 11, wherein the processor is further configured to: analyze the passenger data of the at least one potentially late passenger to determine a travel companion.

13. The system of claim 12, wherein the processor is further configured to: analyze the location data associated with the travel companion to determine an on-time arrival time for the travel companion.

14. The system of claim 13, wherein the processor is further configured to: transmit a companion notification for the travel companion based on the location data for the at least one potentially late passenger.

15. The system of claim 13, wherein the processor is further configured to:
reschedule the travel companion based at least in part on the at least on potentially late passenger accepting an offer in the notification.

16. The system of claim 10, wherein the processor is further configured to:
analyzing the passenger data to determine at least one standby passenger for the mode of transportation; and
assigning a ticket to the at least on standby passenger based at least in part on the at least one potentially late passenger accepting an offer in the notification.

17. The system of claim 10, wherein the mode of transportation comprises an airplane.

18. A computer program product for booking management, the computer program product comprising a computer readable storage medium having program instructions embodied therewith, wherein the computer readable storage medium is not a transitory signal per se, the program instructions executable by a processor to cause the processor to perform a method comprising:
receiving booking data for a mode of transportation, wherein the booking data comprises passenger data and departure data for the mode of transportation;
analyzing the passenger data to identify one or more passengers for the mode of transportation;
obtaining location data associated with each of the one or more passengers;
analyzing the location data to determine at least one potentially late passenger from the one or more passengers; and
transmitting an offer to the at least one potentially late passenger based on the location data for the at least one potentially late passenger.

19. The computer program product of claim 18, wherein the offer comprises an offer to sell a ticket for the at least one potentially late passenger.

20. The computer program product of claim 18, wherein the mode of transportation comprises an airplane.
